(19) United States
(12) Patent Application Publication
(10) Pub. No.: US 2007/0296735 A1
(43) Pub. Date: Dec. 27, 2007

(54) System for and method of managing drawings

(75) Inventor: Akio Ishikawa, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/812,309

(22) Filed: Jun. 18, 2007

(30) Foreign Application Priority Data
Jun. 20, 2006 (JP) 2006-169849

(51) Int. Cl. G09G 5/00

(52) U.S. Cl. 345/619

(57) ABSTRACT

After CAD drawing data and drawing attribute data are registered in a data memory by a CAD drawing registering means, the CAD drawing data edited by a CAD drawing editing unit. At this time, it is confirmed whether the CAD drawing data is being edited by another operator or not based on a CAD flag of the CAD drawing data which is set in the drawing attribute data by an editing authority setting means. If the CAD drawing data is not being edited by another operator, then the CAD flag is set to acquire an editing authority, allowing only a particular editor to edit the CAD drawing data.

### BACKGROUND OF THE INVENTION

1. Field of the Invention

The present invention relates to a system for and a method of managing drawings by storing and managing drawing data as a database and retrieving and editing the stored drawing data.

2. Description of the Related Art

Heretofore, there has been developed a system for storing drawing data obtained by reading a number of design drawings, specifications, etc. with a scanner, or CAD drawing data generated using a CAD device (Computer Aided Design device), as digital data in a mass recording medium such as a hard disk, a CD-ROM, a DVD, or the like, setting retrieval conditions when necessary, retrieving a desired design drawing or drawings, etc. according to the set retrieval conditions, and editing, e.g., revising, the retrieved design drawing or drawings, etc. For details, reference should be made to Japanese Laid-Open Patent Publication No. 6-243182.

With the conventional system, it is up to individuals to manage the drawing data stored in the recording medium under present circumstances. If a plurality of editors edit the same drawing data, then the management of the drawing data tends to be confused and to have its reliability lowered.

### SUMMARY OF THE INVENTION

It is a general object of the present invention to provide a system for and a method of managing drawings to allow drawing data that can be edited by a plurality of editors to be managed with high reliability.

A major object of the present invention is to provide a system for and a method of managing drawings to allow drawing data to be managed with high reliability while avoiding overlapping editing processes and also avoiding the registration of overlapping drawing data.

Another object of the present invention is to provide a system for and a method of managing drawings to allow an editing history of edited drawing data to be managed.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a drawing management system according to an embodiment of the present invention;

FIG. 2 is a functional block diagram of essential units of the drawing management system according to the embodiment of the present invention;

FIG. 3 is a flowchart of a process of registering a CAD drawing;

FIG. 4 is a view of a menu screen displayed on a monitor of a drawing registering/retrieving unit;

FIG. 5 is a view of a drawing number booking screen displayed on the monitor of the drawing registering/retrieving unit;

FIG. 6 is a view of a registration request slip generated by the drawing registering/retrieving unit;

FIG. 7 is a view of a CAD file registration screen displayed on the monitor of the drawing registering/retrieving unit;

FIG. 8 is a flowchart of a process of editing a CAD file;

FIG. 9 is a view of a retrieval condition input screen displayed on the monitor of the drawing registering/retrieving unit;

FIG. 10 is a view of a CAD file editing screen displayed on the monitor of the drawing registering/retrieving unit; and

FIG. 11 is a view of an individual drawing browsing screen displayed on the monitor of the drawing registering/retrieving unit.

### DESCRIPTION OF THE PREFERRED EMBODIMENT

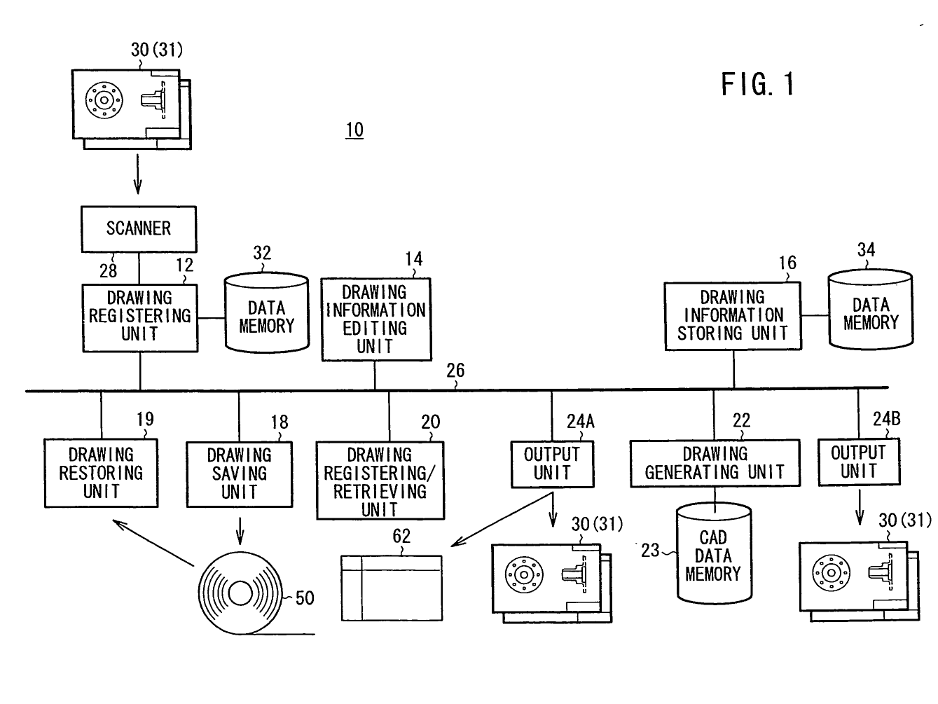

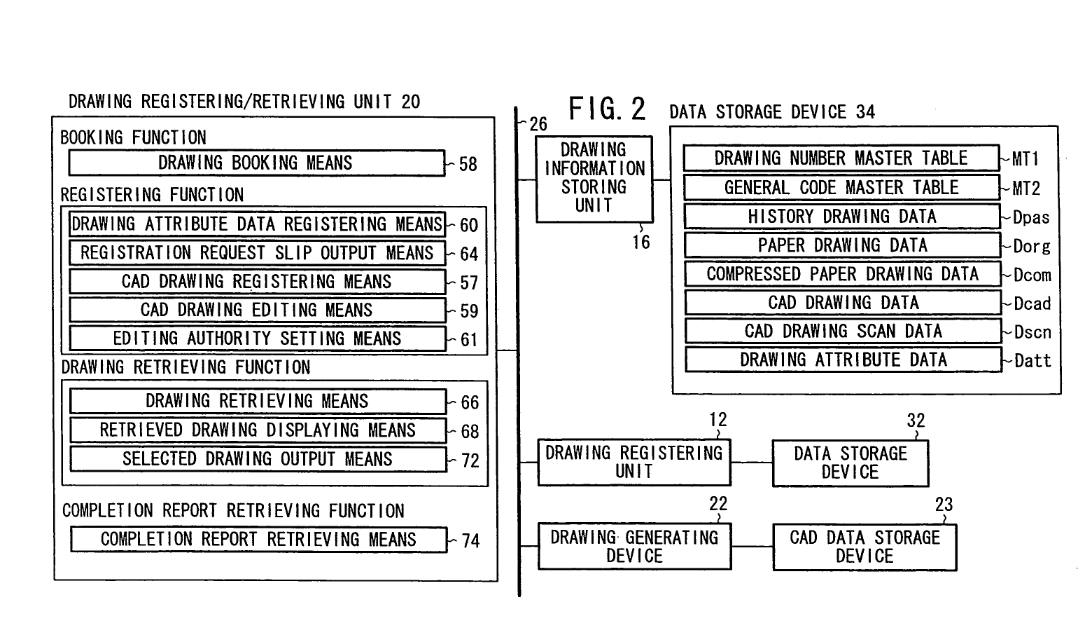

FIG. 1 shows in block form a drawing management system 10 according to an embodiment of the present invention. FIG. 2 is a functional block diagram of essential units of the drawing management system 10.

As shown in FIGS. 1 and 2, the drawing management system 10 comprises a drawing registering unit 12, a drawing information editing unit 14, a drawing information storing unit 16 (drawing storing means), a drawing saving unit 18, a drawing restoring unit 19, a drawing registering/retrieving unit 20, a drawing generating unit 22, and output units 24A, 24B which are all connected to each other by a network 26.

The drawing registering unit 12 reads a paper drawing 30 or a CAD drawing 31 with a scanner 28 connected thereto, and registers the read data as paper drawing data Dorg, which is not subjected to a compression process such as a deflate process or the like, or CAD drawing scan data Dscn, which is produced by reading the CAD drawing 31 at a low resolution, in a data memory 32. The data memory 32 registers therein the paper drawing data Dorg and the CAD drawing scan data Dscn and also drawing attribute data Datt edited by the drawing information editing unit 14 in association with the paper drawing data Dorg and the CAD drawing scan data Dscn.

The paper drawing 30 is a drawing directly generated on a sheet of paper using a drafting machine, and includes not only a drawing of a machine, a facility, a circuit, or the like, but also a document image of every type of paper document such as an inspection document, a calculation document, an estimation document, or the like about a facility construction. The CAD drawing 31 is a drawing generated and output to a sheet of paper by the drawing generating unit 22 which serves as a CAD device (Computer Aided Design device). The drawing attribute data Datt is data representative of an ID number and a drawing title identifying the paper drawing 30 or the CAD drawing 31, department information as to a department, a line, etc. corresponding to the paper drawing 30 or the CAD drawing 31, a generation date of the paper drawing 30 or the CAD drawing 31, the name of a person in charge of the paper drawing 30 or the CAD drawing 31, etc.

The drawing information editing unit 14 controls the drawing registering unit 12 to register and edit the paper drawing 30 or the CAD drawing 31, and also controls the drawing information storing unit 16 to store various data including paper drawing data Dorg, compressed paper drawing data Dcom, CAD drawing data Dscn, drawing attribute data Datt, a drawing number master table MT1, and a general code master table MT2, in a data memory 34 that is connected to the drawing information storing unit 16.

The compressed paper drawing data Dcom is data produced by compressing, e.g., deflating, the paper drawing data Dorg. The drawing number master table MT1 is a management table for setting drawing numbers for paper drawings 30 and CAD drawings 31 without overlaps, and for storing drawing booking data including the drawing numbers prior to the registration of drawings. The general code master table MT2 is a management table for storing keywords for setting and retrieving drawing attribute data Datt, and for storing, as keywords, the types of drawings to be registered, the names of persons in charge of drawings, and department information corresponding to drawings.

The drawing information storing unit 16 stores, in addition to the above data, CAD drawing data Dcad generated by the drawing generating unit 22 and history drawing data Dpas produced when CAD drawing data Dcad is edited.

The drawing saving unit 18 saves a paper drawing 30 and a CAD drawing 31, directly in an image format, and also saves drawing attribute data Datt related to these drawings, in a restorable visualized code format, on a microfilm 50 through a CD-ROM or the like.

The drawing restoring unit 19 reads information recorded on the microfilm 50 and restores drawing attribute data Datt, paper drawings 30, and CAD drawings 31 therefrom.

The drawing registering/retrieving unit 20 is a computer assigned to each operator who is desirous of registering paper drawings 30 and CAD drawings 31 in and retrieving paper drawings 30 and CAD drawings 31 from the drawing information storing unit 16. The drawing registering/retrieving unit 20 has a booking function for booking the registration of a drawing, a registering function for registering drawing attribute data Datt based on drawing booking data, generating a registration request slip, and registering and editing CAD drawings 31, a drawing retrieving function for retrieving a desired drawing, and a completion report retrieving function for retrieving a completion report which is a construction report that comprises a plurality of registered drawings.

The booking function has a drawing booking means 58 for booking in advance the drawing number of a drawing to be registered without overlaps, using the drawing number master table MT1 stored in the data memory 34.

The registering function has a drawing attribute data registering means 60 for registering drawing attribute data Datt of the drawing for a drawing number registered by the drawing booking means 58, a registration request slip output means 64 for outputting a registration request slip 62 (see FIG. 1) from the output unit 24A based on the registered drawing attribute data Datt, a CAD drawing registering means 57 for registering a CAD drawing 31 generated by the drawing generating unit 22, a CAD drawing editing means 59 (drawing editing means) for editing registered CAD drawings 31, and an editing authority setting means 61 for setting an editing authority for the operator to edit a CAD drawing 31. A drawing registrar or a drawing inspector/approver is provided with the registration request slip 62, together with the drawing to be registered, for a process of registering a paper drawing 30 or a process of inspecting and approving a paper drawing 30 and a CAD drawing 31.

The drawing retrieving function has a drawing retrieving means 66 for setting a desired drawing retrieving condition and retrieving a paper drawing 30 or a CAD drawing 31 having drawing attribute data Datt that matches the drawing retrieving condition from the data memory 34, a retrieved drawing displaying means 68 for generating the retrieved paper drawing 30 from compressed drawing image data Dcom or the retrieved CAD drawing 31 from CAD drawing scan data Dscn, and displaying the paper drawing 30 or the CAD drawing 31 together with the drawing attribute data Datt, a selected drawing displaying means 70 for displaying the paper drawing 30 or the CAD drawing 31 of small data amount displayed by the retrieved drawing displaying means 68 as a detailed paper drawing 30 or a detailed CAD drawing 31 using paper drawing data Dorg or the CAD drawing data Dcad, and a selected drawing output means 72 for outputting the paper drawing 30 or the CAD drawing 31 displayed by the selected drawing displaying means 70 from the output unit 24B.

The completion report retrieving function has a completion report retrieving means 74 for setting a desired construction retrieval condition and retrieving a completion report having drawing attribute data Datt that matches the construction retrieval condition. The retrieved completion report can be output from the output unit 24B.

The drawing generating unit 22 comprises a CAD device. CAD drawing data Dcad representing a CAD drawing 31 generated by the drawing generating unit 22 is stored in a CAD data memory 23. The CAD drawing data Dcad is registered and edited by the CAD drawing registering means 57 and the CAD drawing editing means 59 of the drawing registering/retrieving unit 20, and stored together with the drawing attribute data Datt in the data memory 34.

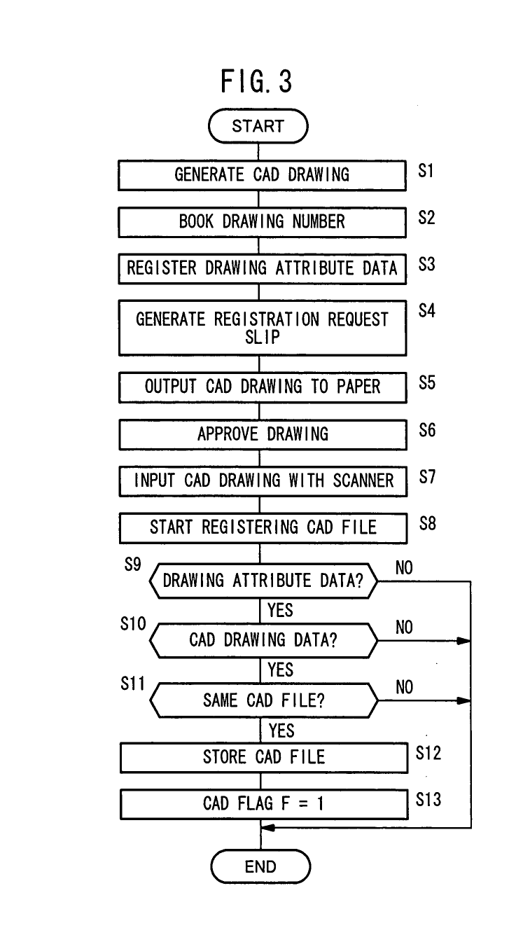

The drawing management system 10 according to the present embodiment is basically constructed as described above. A process of newly registering a CAD drawing 31 using the drawing management system 10 will be described below with reference to a flowchart shown in FIG. 3.

First, a CAD drawing 31 is generated using the drawing generating unit 22 in step S1. CAD drawing data Dcad representative of the generated CAD drawing 31 is recorded in the CAD data memory 23.

Then, the drawing number of the CAD drawing 31 to be registered is reserved using the drawing registering/retrieving unit 20 in step S2.

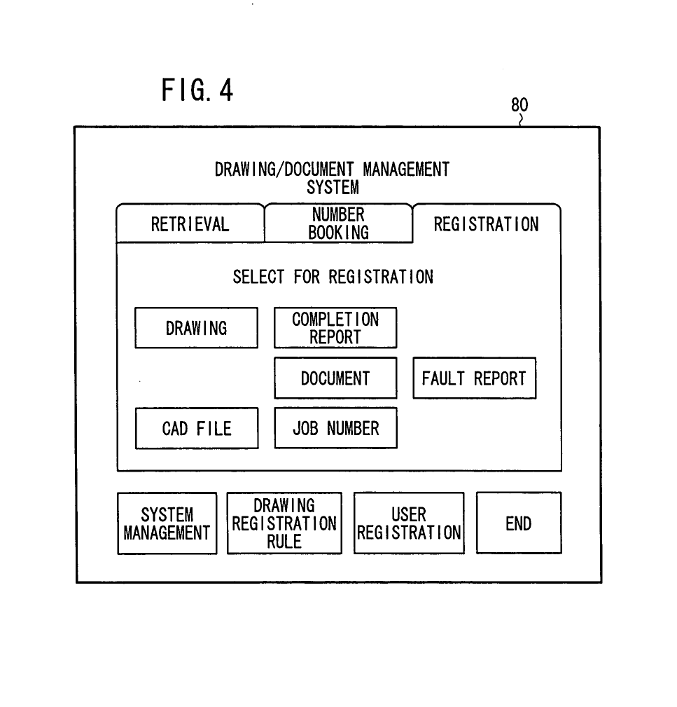

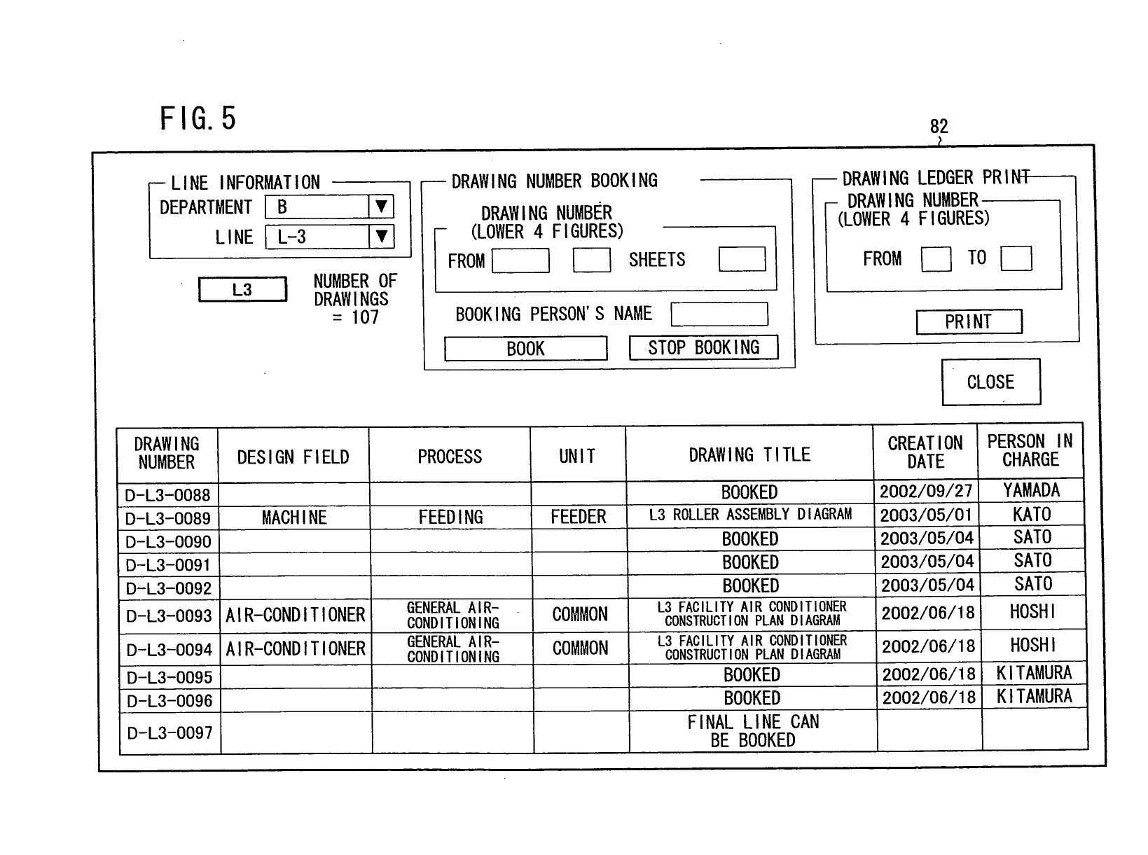

At this time, the monitor of the drawing registering/retrieving unit 20 displays a menu screen 80 shown in FIG. 4. When the operator presses a “NUMBER BOOKING” button on the menu screen 80, the monitor displays a drawing number booking screen 82 shown in FIG. 5. The operator books the drawing number on the drawing number booking screen 82.

The operator enters information of the department involving the facility relative to the CAD drawing 31 based on the information set in the general code master table MT2 stored in the data memory 34. The drawing booking means 58 displays booking information of, for example, a drawing number in a department B and a line L3, using the drawing number master table MT1 and the drawing attribute data Datt in the data memory 34.

For example, a drawing number D-L3-0088 that has already been reserved by another operator is displayed as “RESERVED” in the column of drawing titles. Therefore, the operator cannot use this drawing number. Another drawing number D-L3-0089, for example, is also a drawing number whose CAD drawing 31 has already been registered because various items of drawing attribute data Datt including a design field, a process, an apparatus, a drawing title, a generated data, and a person in charge are displayed in corresponding columns. Therefore, the operator selects a drawing number other than those registered drawing numbers, e.g., subsequent to a drawing number D-L3-0097.

The operator sets as many drawing numbers that can be reserved as the number of CAD drawings 31 required for registration, enters the name of the booking person, and selects a “BOOKING” button, thus completing the process of booking the drawing number.

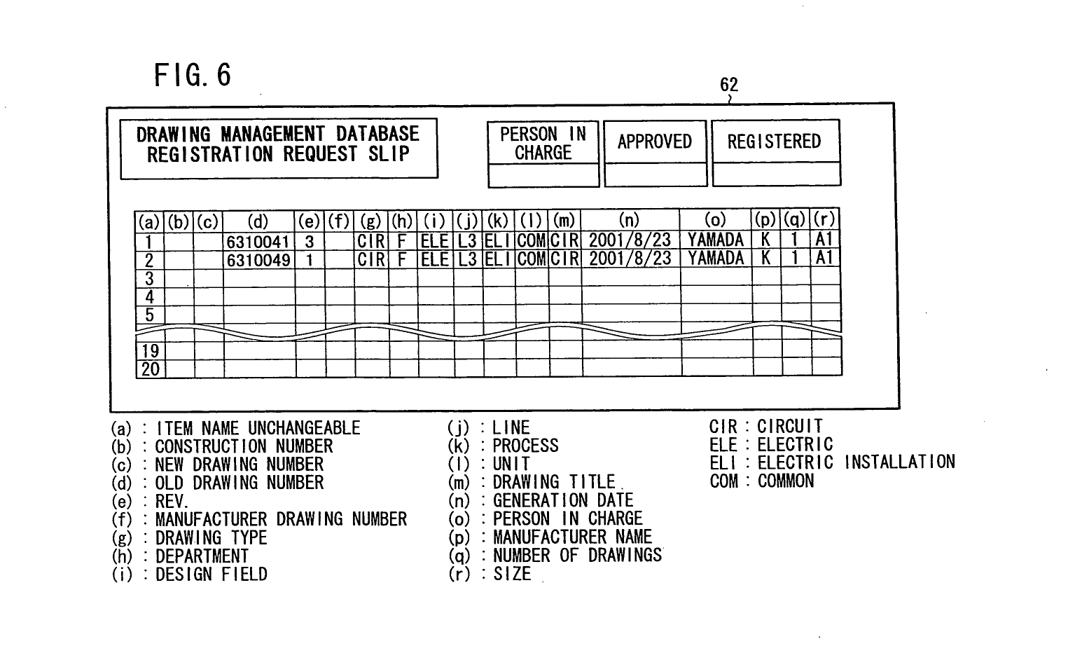

Then, the operator closes the drawing number booking screen 82 and displays a registration request slip 62 shown in FIG. 6. The operator registers necessary drawing attribute data Datt with respect to the respective drawing numbers that have been reserved by the booking function in step S3. For example, the operator enters drawing attribute data Datt including design fields, the names of manufacturers who produced the CAD drawings 31, the construction numbers to which the CAD drawings 31 relates, the designers, the generated dates, the number of sheets of each of the CAD drawings 31, and the drawing sizes, for example.

At this time, the operator enters the drawing attribute data Datt by selecting keywords registered in the general code master table MT2 of the data memory 34. Therefore, drawing attribute data Datt are prevented from being entered in different formats by different operators.

After the operator has set the drawing attribute data Datt as described above, the registration request slip output means 64 outputs the registration request slip 62 from the output unit 24B in step S4. After the drawing number reserved in step S2 for the CAD drawing data Dcad recorded in the CAD data memory 23 of the drawing generating unit 22 is set as a file name, the CAD drawings 31 registered in the registration request slip 62 are output from the output unit 24A in step S5.

The operator signs a “PERSON IN CHARGE” column in the registration request slip 62, and submits the registration request slip 62 as attached to the CAD drawing 31 to be registered to a drawing inspector/approver. The drawing inspector/approver confirms the contents of the CAD drawing 31, and signs an “APPROVED” column in the registration request slip 62 in step S6.

The CAD drawing 31 that has been approved is transferred, together with the registration request slip 62, to a drawing registrar for registration. The drawing registrar sets a drawing reading condition depending on the CAD drawing 31 to be registered, using the drawing information editing unit 14, and reads the CAD drawing 31 and the registration request slip 62 with the scanner 28 in step S7. Since CAD drawing data Dcad of high resolution has already been recorded in the CAD data memory 23, the scanner 28 reads the CAD drawing 31 at a low resolution. CAD drawing scan data Dscn produced by reading the CAD drawing 31 is temporarily recorded in the data memory 32.

Then, using the drawing registering/retrieving unit 20, the operator starts a process of registering a CAD file made up of the CAD drawing data Dcad of the CAD drawing 31 generated by the drawing generating unit 22, the CAD drawing scan data Dscn registered by the drawing registering unit 12, and the drawing attribute data Datt about the CAD drawing data Dcad and the CAD drawing scan data Dscn in step S8.

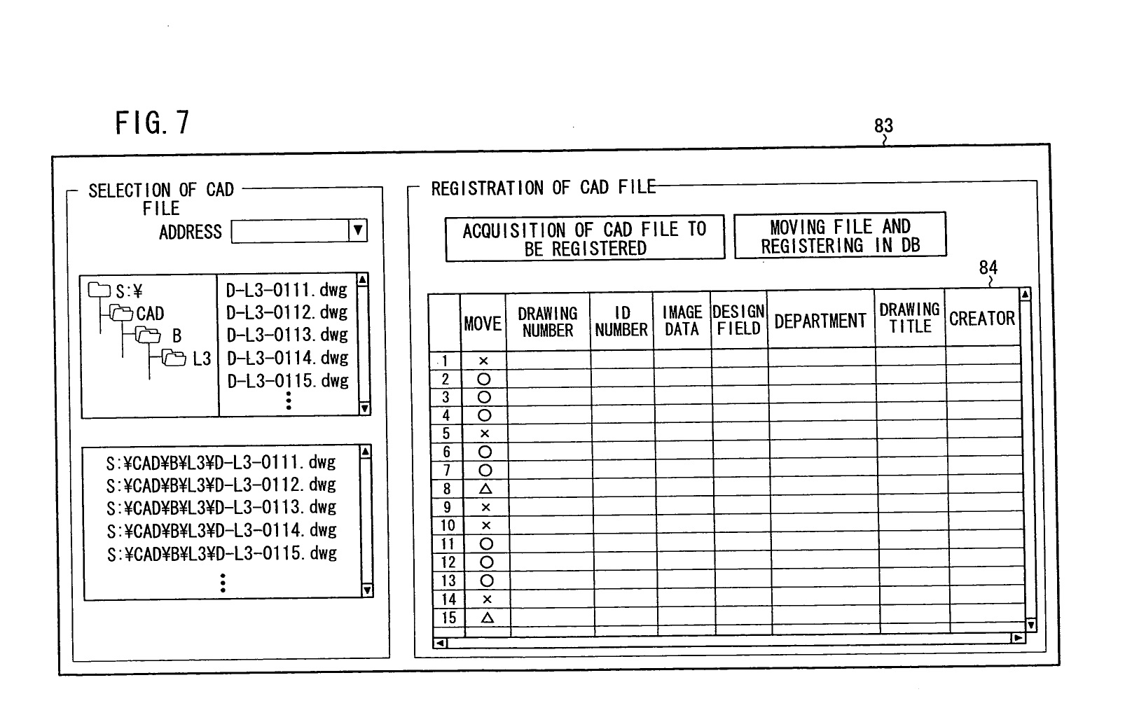

When the operator selects a “REGISTRATION” button and then a “CAD FILE” button on the menu screen 80 shown in FIG. 4, a CAD file registration screen 83 shown in FIG. 7 is displayed. The operator selects a folder, e.g., a folder L3, which stores the CAD drawing data Dcad, on the CAD file registration screen 83, and selects a CAD file to be registered from displayed CAD files. Thereafter, the operator selects an “ACQUISITION OF FILE TO BE REGISTERED” button.

When the “ACQUISITION OF FILE TO BE REGISTERED” button is selected, the CAD drawing registering means 57 of the drawing registering/retrieving unit 20 determines whether drawing attribute data Datt required for the CAD file selected by the operator has already been registered in the drawing management system 10 or not in step S9. If the drawing attribute data Datt has already been registered in the drawing management system 10, then the CAD drawing registering means 57 determines whether CAD drawing data Dcad relative to the drawing attribute data Datt exists in the CAD data memory 23 of the drawing generating unit 22 or not in step S10. If the CAD drawing data Dcad exists in the CAD data memory 23, then the CAD drawing registering means 57 determines whether a CAD file having the same name as the file name in the CAD data memory 23 exists in the data memory 34 of the drawing information storing unit 16 or not in step S11.

The column “MOVE” of a to-be-registered file list 84 displays ◯ (circle) if there are drawing attribute data Datt and CAD drawing data Dcad and there is not a CAD file of the same name in the data memory 34, × (x) if there are not drawing attribute data Datt and CAD drawing data Dcad, and Δ (triangle) if there is a CAD file of the same name in the data memory 34.

Then, when the operator selects a “MOVING FILE AND REGISTERING IN DB” button on the CAD file registration screen 83, the CAD drawing registering means 57 selects only CAD files with respect to which ◯ is displayed in the column “MOVE”, and moves the drawing attribute data Datt, the CAD drawing data Dcad, and the CAD drawing scan data Dscn for the selected CAD files to the data memory 34 of the drawing information storing unit 16, which stores these data in step S12. At this time, the editing authority setting means 61 of the drawing registering/retrieving unit 20 sets a CAD flag F of the drawing attribute data Datt of the CAD files stored in the data memory 34, to “1”, thereby canceling the editing authority by the operator on the CAD files in step S13. As a result, it is possible for any operator to edit the CAD files.

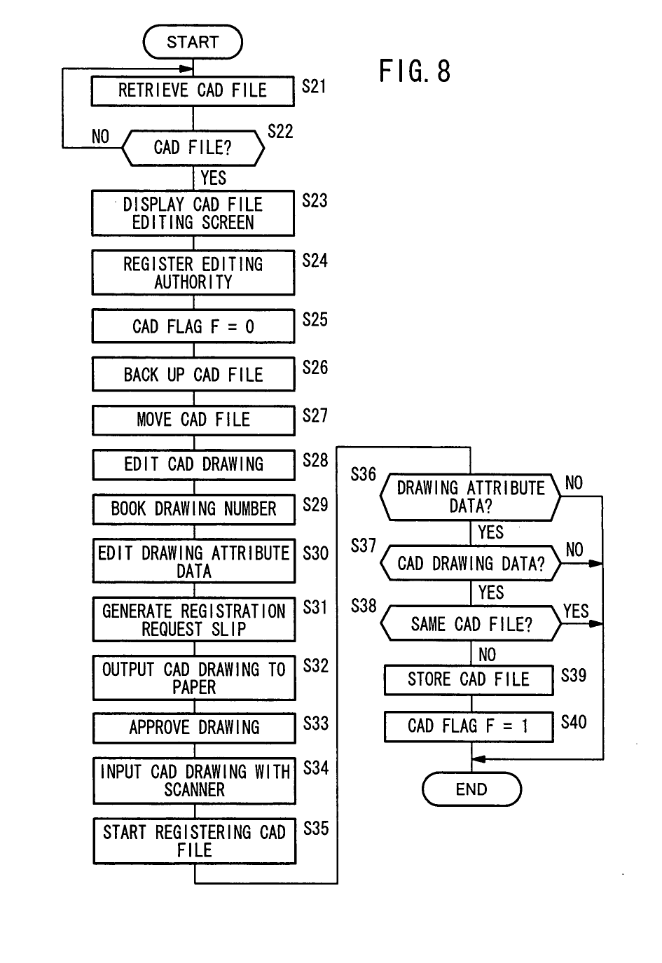

A process of editing a CAD file stored in the data memory 34 will be described below with reference to a flowchart shown in FIG. 8.

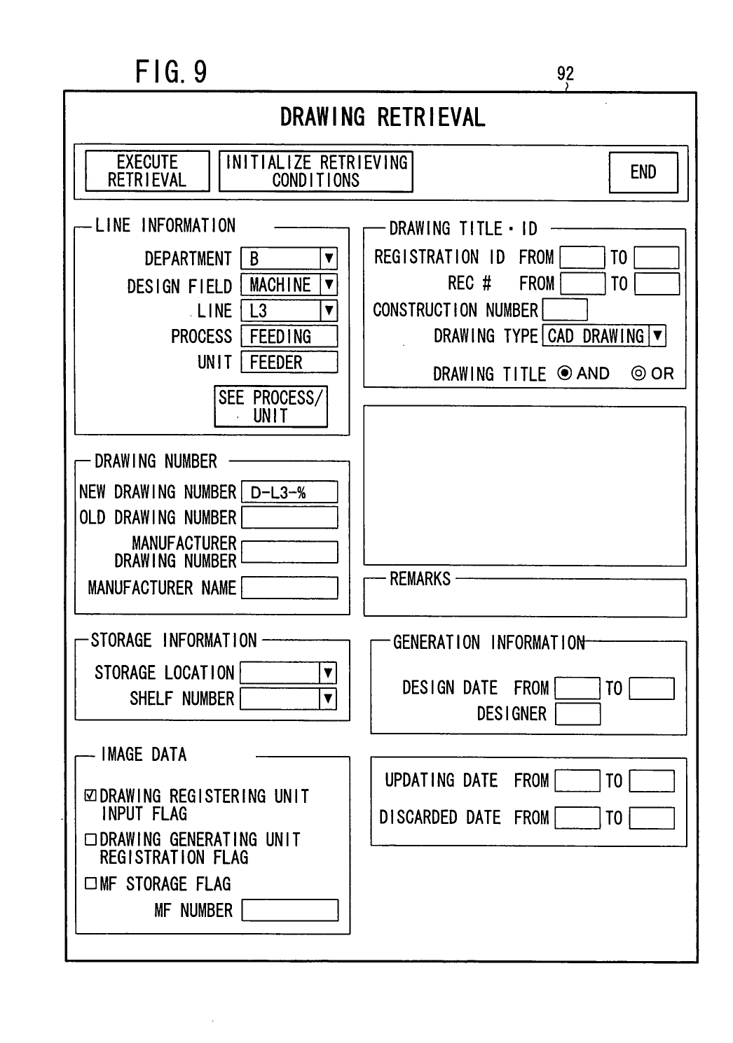

When the operator selects a “RETRIEVAL” button on the menu screen 80 displayed on the monitor of the drawing registering/retrieving unit 20 and then selects a “CAD FILE” button, a retrieval condition input screen 92 shown in FIG. 9 is displayed on the monitor. The operator enters necessary retrieval conditions into the retrieval condition input screen 92. When the operator selects a “RETRIEVAL EXECUTION” button, the drawing retrieving means 66 starts a retrieving process in step S21.

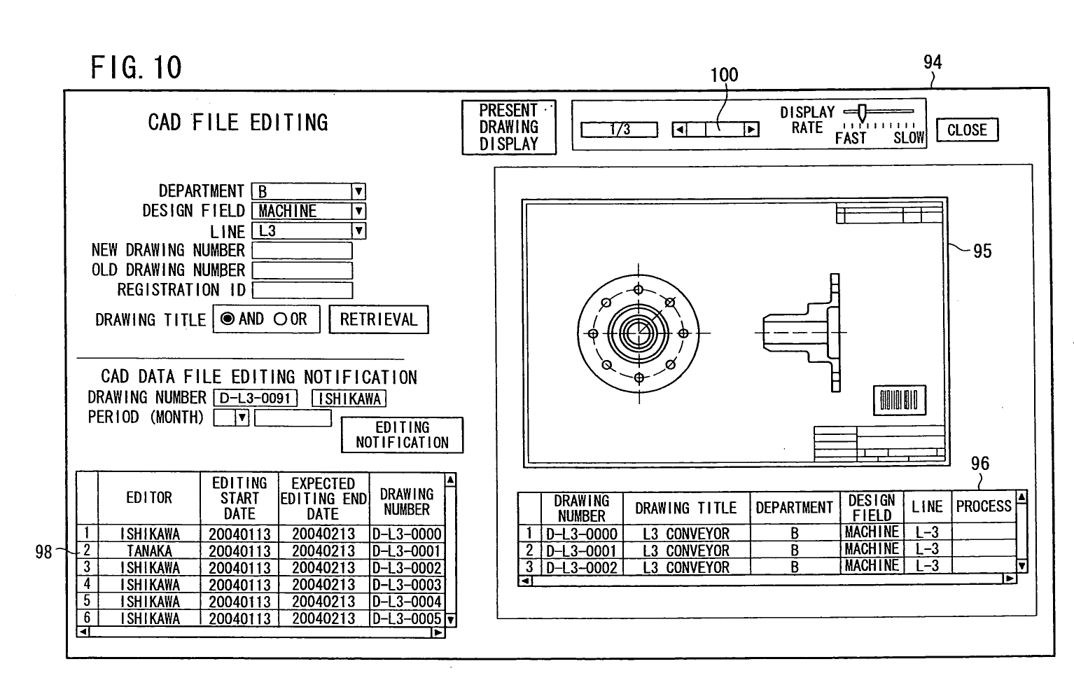

The drawing retrieving means 66 retrieves CAD files which match the retrieval conditions from the data memory 34 in step S22, and displays the retrieval results as a CAD file editing screen 94 (display means) shown in FIG. 10 in step S23. Specifically, the CAD file editing screen 94 displays a CAD drawing 95 made up of CAD drawing scan data Dscn of a CAD file that matches the retrieval conditions, a drawing attribute data list 96 made up of the drawing attribute data Datt of the retrieved CAD files, and an editing authority information list 98 for the retrieved CAD files.

The CAD drawing 95 is generated based on CAD drawing scan data Dscn of small data amount, and can be scrolled quickly when the operator clicks a scroll bar 100 displayed on the CAD file editing screen 94. The drawing attribute data Datt of the CAD drawing 95 displayed on the CAD file editing screen 94 can be confirmed based on the drawing attribute data list 96 and the editing authority information list 98.

The editing authority information list 98 displays information about editing authorities set for the retrieved CAD files, i.e., the names of editors for editing the CAD files, editing periods, and the drawing numbers of the CAD files.

The operator scrolls the CAD drawings 95 displayed on the CAD file editing screen 94 and selects a drawing to be edited. Thereafter, the operator selects an “EDITING NOTIFICATION” button to register the editing authority, including the editing period, for the CAD drawing 95 in step S24.

The editing authority setting means 61 checks the CAD flag F set as the drawing attribute data Datt of the selected CAD drawing 95. If the CAD flag F is set to 1 (step S13) when a CAD drawing 31 is newly registered and the CAD drawing data Dcad of the CAD drawing 95 is not being edited by another operator, then the editing authority setting means 61 sets the CAD flag F to 0 and assigns the editing authority for the CAD drawing 95 to the present operator in step S25. The CAD drawing 95 whose CAD flag F is set to 0 cannot be edited by other operators who lack the editing authority. Accordingly, any overlapping editing processes for the CAD drawing 95 are avoided.

The CAD file for which the CAD flag F is set to 0 is backed up as history drawing data Dpas in a backup folder in the data memory 34 in step S26. After the CAD file is backed up in the data memory 34, the original CAD file is moved to the drawing generating unit 22 in step S27, and then the CAD drawing 95 is edited in step S28.

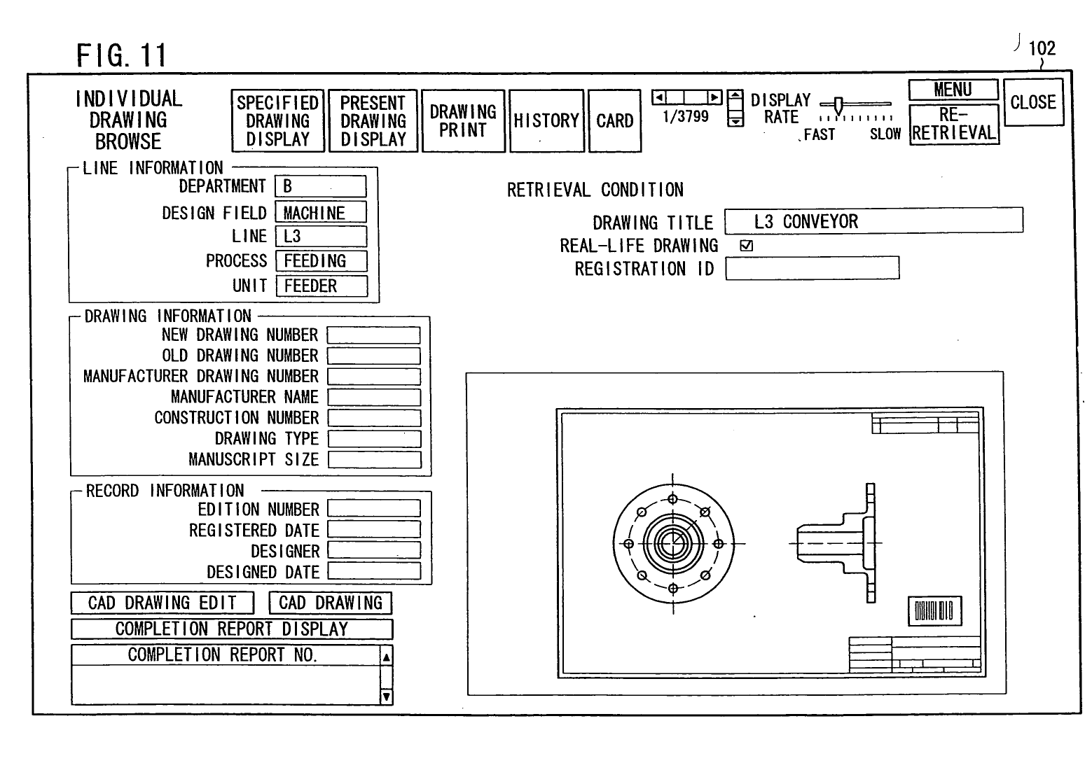

Alternatively, when the operator selects the “RETRIEVAL” button on the menu screen 80, the operator may select a “DRAWING” button to display an individual drawing browsing screen 102 shown in FIG. 11 as retrieval results. Thereafter, the operator may select a “CAD DRAWING EDITING” button to register the editing authority, and then select a “CAD DRAWING” button to activate an application for editing the CAD drawing data Dcad, whereupon the drawing registering/retrieving unit 20 may edit the CAD drawing data Dcad.

After having edited the CAD drawing, the operator reserves a drawing number in the same manner as if a CAD drawing 31 is to be newly registered in step S29. Then, the operator edits the drawing attribute data Datt in step S30. At this time, the operator may set version information which represents the editing history data of the original CAD file as the drawing attribute data Datt.

A registration request slip for the edited CAD drawing 31 is generated in step S31. After the CAD drawing 31 is output to a sheet of paper in step S32, it is approved by the drawing inspector/approver in step S33. The CAD drawing 31 is read using the scanner 28 in step S34, and the CAD file is registered in the data memory 34 in step S35. When the CAD file is registered, if there are drawing attribute data Datt and CAD drawing data Dcad of the CAD file in steps S36, S37 and if there is not a CAD file of the same name in the CAD data memory 34 in step S38, then the drawing attribute data Datt, the CAD drawing data Dcad, and the CAD drawing scan data Dscn of the CAD file are stored in the CAD data memory 34 in step S39, and the CAD flag F is changed to 1 to cancel the editing authority in step S40. Therefore, it is possible for other operators to edit the registered CAD file.

With the above drawing management system 10, the CAD drawing data Dcad of a CAD drawing 31 may be registered in the data memory 34 and the CAD drawing data Dcad may be retrieved and edited when necessary, and the paper drawing data Dorg of a paper drawing 30 may be registered in the data memory 34 and both CAD drawing data Dcad and compressed paper drawing data Dcom may be retrieved.

For registering a paper drawing 30, the paper drawing 30 is read using the scanner 28, and the paper drawing data Dorg and the drawing attribute data Datt thereof which are obtained and stored in the data memory 34. Compressed paper drawing data Dcom generated when the paper drawing data Dorg is compressed by the drawing information editing unit 14 is registered in the data memory 34. For retrieving a paper drawing 30, compressed images based on the compressed paper drawing data Dcom are displayed. The displayed compressed images are scrolled to retrieve the desired paper drawing 30 at a high speed.

Although a certain preferred embodiment of the present invention has been shown and described in detail, it should be understood that various changes and modifications may be made therein without departing from the scope of the appended claims.

What is claimed is:

1. A system for managing a drawing, comprising:
drawing storing means for storing drawing data together with drawing attribute data thereof;
drawing retrieving means for retrieving said drawing data stored in said drawing storing means based on said drawing attribute data;
drawing editing means for editing said drawing data retrieved by said drawing retrieving means; and
editing authority setting means for setting an editing authority with respect to said drawing data to be edited by said drawing editing means for allowing said drawing data to be edited by only a particular editor;
whereby said drawing data with respect to which said editing authority is set can be edited by said particular editor.

2. A system according to claim 1, wherein said drawing data includes CAD (Computer Aided Design) drawing data.

3. A system according to claim 1, wherein said editing authority setting means has a function to cancel said editing authority set with respect to said drawing data.

4. A system according to claim 1, wherein said drawing attribute data includes data about the editing authority set by said editing authority setting means.

5. A system according to claim 1, wherein said drawing attribute data includes editing history data about said drawing data edited by said drawing editing means.

6. A system according to claim 1, wherein said drawing storing means stores compressed drawing data produced when said drawing data is compressed, and said drawing retrieving means retrieves said compressed drawing data based on said drawing attribute data.

7. A system according to claim 1, further comprising
display means for displaying a setting status of said editing authority together with said retrieved drawing data.

8. A method of managing a drawing, comprising the steps of:
retrieving drawing data stored in a drawing storing means based on drawing attribute data of said drawing data;
setting an editing authority with respect to the retrieved drawing data for allowing said drawing data to be edited by only a particular editor; and
editing the drawing data with respect to which said editing authority is set, among retrieved drawing data.

9. A method according to claim 8, further comprising the step of
canceling said editing authority set with respect to the edited drawing data.

10. A method according to claim 8, wherein compressed drawing data produced when said drawing data is compressed is retrieved based on the drawing attribute data of said drawing data.

11. A method according to claim 8, further comprising the step of
displaying a setting status of said editing authority together with said retrieved drawing data.
